(19) United States
(12) Patent Application Publication
(10) Pub. No.: US 2022/0062831 A1
(43) Pub. Date: Mar. 3, 2022

(54) METAL-ORGANIC FRAMEWORK MATERIAL/MEMBRANE COMPOSITE MATERIAL, PREPARATION METHOD AND USE THEREOF

(71) Applicant: Jilin Jianzhu University, Changchun (CN)

(72) Inventors: Yingzi Lin, Changchun (CN); Ruijun Ren, Changchun (CN); Feng Xiao, Changchun (CN); Chunyan Shi, Changchun (CN); Yingji Song, Changchun (CN)

(73) Assignee: Jilin Jianzhu University

(21) Appl. No.: 17/034,046

(22) Filed: Sep. 28, 2020

(30) Foreign Application Priority Data
Sep. 2, 2020 (CN) 202010908512.3

(51) Int. Cl. B01D 69/12; B01D 71/36; B01D 71/42; B01D 67/00; B01D 61/14; C02F 1/44

(52) U.S. Cl. CPC B01D 69/125; B01D 71/36; B01D 71/42; B01D 2323/46; B01D 61/145; C02F 1/444; B01D 2323/08; B01D 67/0006

(57) ABSTRACT

The present disclosure provides a metal-organic framework material/membrane composite material, a preparation method and a use thereof, which belongs to the technical field of water treatment. The method includes: mixing a membrane material with an alkali liquor, and performing a hydrolysis to obtain a hydrolyzed membrane; impregnating the hydrolyzed membrane in a metal salt aqueous solution and a framework organic solution in sequence, to form a metal-organic framework material/membrane composite material. In the composite material obtained by this method, the bonding strength between the membrane material and the metal-organic framework material is high, and it is not easy to separate them during the use and the composite material could be widely used. At the same time, the metal-organic framework material/membrane composite material obtained by this method has dual functionality, and thus could improve the efficiency of water treatment.

### CROSS REFERENCE TO RELATED APPLICATION

This application claims the priority of Chinese Patent Application No. 202010908512.3, entitled “Metal-organic framework material/membrane composite material, preparation method and use thereof” filed with the China National Intellectual Property Administration on Sep. 2, 2020, which is incorporated herein by reference in its entirety.

### TECHNICAL FIELD

The present disclosure relates to the technical field of water treatment, in particular to a metal-organic framework material/membrane composite material, a preparation method and a use thereof.

### BACKGROUND

With the continuous increasing of China's population and economy, the demand for per capita available amount of water resources is increasing. China is facing severe problems of water shortage and pollution. Sewage treatment has become the most urgent and effective treatment method to solve water resources problems at present. Conventional membrane separation technology usually uses microfiltration membrane and ultrafiltration membrane. Due to the fact that microfiltration membrane or ultrafiltration membrane has a good treating ability for suspended and colloidal macromolecular organic matter, but has a poor retention capacity for some organic components which are difficult to dissolve and have a size smaller than the membrane pore size, it has become a current research hotspot that how to prepare membrane materials with excellent selectivity and functionality.

Zeolitic Imidazolate Frameworks (ZIFs), as a new type of metal-organic frameworks (MOFs), are hybrid framework porous ordered structures composed of metal clusters that are formed by combining inorganic metal ions with organic imidazole/imidazole salt ligands through coordination bonds. ZIFs not only have the advantages of MOFs material, such as large specific surface area, high porosity and adjustable pore size, but also have the high stability and chemical properties of zeolite. Therefore, the ZIFs have attracted a large number of researchers to use it as loads of membrane materials. Researchers have successfully prepared composite membranes containing MOFs materials such as ZIFs and MILs. Studies have shown that metal-organic framework composite membranes have excellent treatment effects in the fields of gas/liquid, solid/liquid separation, seawater desalination and catalysis. In the prior art, the molecular sieve composite membranes were prepared by coating molecular sieves on membrane materials; however, in the composite membranes obtained by such methods, the bonding strength between the molecular sieves and the membrane materials is weak, and the coating thickness is relatively thick, leading to a limited treatment effect of molecular sieve composite materials.

### SUMMARY

In view of this, an object of the present disclosure is to provide a metal-organic framework material/membrane composite material, a preparation method and a use thereof. In the composite material obtained by the preparation method provided by the present disclosure, the bonding strength between the membrane material and the metal-organic framework material is high, and it is not easy to separate them during later use, and thus the composite material could be widely used.

In order to achieve the above object, the present disclosure provides the following technical schemes:

The present disclosure provides a method for preparing a metal-organic framework material/membrane composite material, comprising the following steps:

mixing a membrane material with an alkali liquor, and performing a hydrolysis to obtain a hydrolyzed membrane; and

impregnating the hydrolyzed membrane in a metal salt aqueous solution and a framework organic solution in sequence, to form a metal-organic framework material/membrane composite material.

In some embodiments, the membrane material is selected from the group consisting of polyacrylonitrile membrane, polytetrafluoroethylene membrane and bisphenol polysulfone membrane.

In some embodiments, the alkali liquor has a concentration of 1-3 mol/L.

In some embodiments, the hydrolysis is carried out at a temperature of 50-65° C. for 1-3 h.

In some embodiments, the metal salt aqueous solution is selected from the group consisting of a cobalt salt aqueous solution and a zinc salt aqueous solution; the framework organic solution is a 2-methylimidazole n-hexane organic solution.

In some embodiments, the metal salt aqueous solution has a concentration of 0.01-0.08 mol/L, and the molar concentration ratio of the metal salt aqueous solution to the framework organic solution is 1:(1-8).

In some embodiments, the hydrolyzed membrane is impregnated in the metal salt aqueous solution for 1-10 h.

In some embodiments, the hydrolyzed membrane is impregnated in the framework organic solution for 0.5-2 h.

The present disclosure further provides a metal-organic framework material/membrane composite material obtained by the method described in the above technical schemes, comprising a membrane material and a thin layer of metal-organic framework material self-grown on the membrane material, wherein the metal-organic framework material contained in the thin layer has a particle size of 100-200 nm.

The present disclosure further provides a use of the metal-organic framework material/membrane composite material described in the above technical schemes as a filter material in a waste water treatment.

The present disclosure provides a method for preparing a metal-organic framework material/membrane composite material, comprising the following steps: mixing a membrane material with an alkali liquor, and performing a hydrolysis to obtain a hydrolyzed membrane; and impregnating the hydrolyzed membrane in a metal salt aqueous solution and a framework organic solution in sequence, to form a metal-organic framework material/membrane composite material. According to the present disclosure, the precursor solution of the metal-organic framework material consists of water phase and organic phase, and a dense and uniform thin layer of the metal-organic framework material is formed on the surface of the membrane material by the mechanism of interfacial polymerization. In the composite material obtained by this method, the bonding strength between the membrane material and the metal-organic framework material is high, and it is not easy to separate them, and thus the composite material could be widely used. At the same time, in this method, the advantages of the metal-organic framework material such as large specific surface area and high porosity are combined with the sieving properties of the membrane material, resulting in a metal-organic framework material/membrane composite material with dual functionality, thereby improving the efficiency of water treatment.

### BRIEF DESCRIPTION OF THE DRAWINGS

FIG. 1 shows the X-ray diffraction (XRD) patterns of the ZIF-8 obtained in Comparative Example 1, and the HPAN membrane and ZIF-8@HPAN membrane obtained in Example 1.

FIG. 2 shows the infrared spectrums of the PAN membrane, the ZIF-8 nano-particles obtained in Comparative Example 1, and the HPAN membrane and ZIF-8@HPAN membrane obtained in Example 1.

FIG. 3 is a scanning electron micrograph of the surface of the HPAN membrane obtained in Example 1.

FIG. 4 is a scanning electron micrograph of the surface of the ZIF-8@HPAN membrane obtained in Example 1.

FIG. 5 is a scanning electron micrograph of the cross section of the ZIF-8@HPAN membrane obtained in Example 1.

FIGS. 6A, 6B show the three-dimensional images of the surface roughness of the HPAN membrane and ZIF-8@HPAN membrane obtained in Example 1.

FIG. 7 shows the distribution diagrams of different elements on the surface of the ZIF-8@HPAN membrane obtained in Example 1.

FIGS. 8A, 8B show variations of the permeation flux, UV₂₅₄ removal rate and TOC removal rate of the HPAN membrane with the contacting time with precursor zinc ions.

FIGS. 9A, 9B show variations of the permeation flux, UV₂₅₄ removal rate and TOC removal rate of the ZIF-8@ HPAN membrane with the concentrations of zinc ion.

FIGS. 10A, 10B show variations of the permeation flux, UV₂₅₄ removal rate and TOC removal rate of the membrane with molar concentration ratio of Hmim/Zn²⁺.

FIGS. 11A, 11B show variations of the permeation flux, UV₂₅₄ removal rate and TOC removal rate of the membrane with interfacial polymerization time.

FIGS. 12A, 12B show variations of the permeation flux, UV₂₅₄ removal rate and TOC removal rate of the membrane with trans-membrane pressure.

FIG. 13 shows the molecular weight distribution graphs of humic acid before and after treated with the HPAN membrane and ZIF-8@HPAN membrane obtained in Example 1.

FIG. 14 shows the TOC removal rates of bovine serum albumin and sodium alginate after treated with the HPAN membrane and ZIF-8@ HPAN membrane obtained in Example 1.

### DETAILED DESCRIPTION OF THE EMBODIMENTS

The present disclosure provides a method for preparing a metal-organic framework material/membrane composite material, comprising the following steps:

mixing a membrane material with an alkali liquor, and performing a hydrolysis to obtain a hydrolyzed membrane; and

impregnating the hydrolyzed membrane in a metal salt aqueous solution and a framework organic solution in sequence, to form a metal-organic framework material/membrane composite material.

In the present disclosure, a membrane material is mixed with an alkali liquor, and then subjected to a hydrolysis to obtain a hydrolyzed membrane.

In some embodiments, the membrane material is selected from the group consisting of polyacrylonitrile (PAN) membrane, polytetrafluoroethylene (PTFE) membrane and bisphenol polysulfone (PSf) membrane. In some embodiments, the membrane material is polyacrylonitrile membrane. In some embodiments, the membrane material has a thickness of 1-2 mm.

In some embodiments, the membrane material is subjected to a pretreatment before being mixed with the alkali liquor. In some embodiments, the pretreatment comprises the following steps: rinsing the membrane raw material with water to remove the impurities on the surface, and then immerging the rinsed membrane material in deionized water for 12 h, to obtain the membrane material.

In some embodiments, the alkali liquor has a concentration of 1-3 mol/L, for example 2 mol/L. In some embodiments, the alkali liquor is a sodium hydroxide aqueous solution. In some embodiments, the hydrolysis is carried out at a temperature of 50-65° C., for example 60° C.; the hydrolysis is carried out for 1-3 h, for example 2 h.

In some embodiments, after the hydrolysis is completed, the hydrolyzed product is cooled to ambient temperature, and then washed. In some embodiments, the reagent used when washing the hydrolyzed product is water. In the present disclosure, there is no special limitation on the washing times, as long as the hydrolyzed membrane material is washed to be neutral.

In the present disclosure, the groups on the surface of the membrane material could be hydrolyzed into carboxyl groups, and the carboxyl groups could coordinate with the metal salt in the subsequent metal salt aqueous solution, making the metal-organic framework material more stable on the surface of the membrane material.

In the present disclosure, after obtaining the hydrolyzed membrane, the hydrolyzed membrane is impregnated in a metal salt aqueous solution and a framework organic solution in sequence, to form a metal-organic framework material/membrane composite material.

In some embodiments, the metal salt aqueous solution is selected from the group consisting of a cobalt salt aqueous solution and a zinc salt aqueous solution. In some embodiments, the cobalt salt aqueous solution is a cobalt nitrate hexahydrate solution. In some embodiments, the zinc salt aqueous solution is an aqueous solution of zinc nitrate hexahydrate. In some embodiments, the metal salt aqueous solution has a concentration of 0.01-0.08 mol/L, for example 0.01 mol/L, 0.02 mol/L, 0.04 mol/L or 0.08 mol/L. In some embodiments, the framework organic solution is a 2-methylimidazole n-hexane organic solution. In some embodiments, the molar concentration ratio of the metal salt aqueous solution to the framework organic solution is 1:(1-8), for example 1:1, 1:2, 1:4 or 1:8.

In the present disclosure, the metal salt aqueous solution and framework organic solution are the precursor solutions of the metal-organic framework material. In some embodiments, the metal-organic framework material is a zeolite imidazolate framework material (ZIFs). When the metal salt aqueous solution is a cobalt salt aqueous solution, and the framework organic solution is a 2-methylimidazole n-hexane organic solution, the obtained metal-organic framework material is ZIF-67; when the metal salt aqueous solution is a zinc salt aqueous solution, and the framework organic solution is a 2-methylimidazole n-hexane organic solution, the obtained metal-organic framework material is ZIF-8. In some embodiments, the solvent of the 2-methylimidazole n-hexane organic solution is a miscible solvent formed by methanol and ethanol. In some embodiments, the volume ratio of methanol, ethanol and n-hexane in the 2-methylimidazole n-hexane organic solution is 1.9:2.5:95.6.

In some embodiments, the hydrolyzed membrane is impregnated in the metal salt aqueous solution for 1-10 h, for example 1 h, 2 h, 5 h or 10 h. In some embodiments, after the impregnation is completed, the obtained first impregnated membrane is washed. In some embodiments, the reagent used when washing the obtained first impregnated membrane is water. In the present disclosure, there is no special limitation on the washing times, as long as the metal ions on the first impregnated membrane can be cleaned. In the specific examples of the present disclosure, the obtained first impregnated membrane is washed for 3-5 times. In the present disclosure, due to strong coordination bond function between the carboxyl group on the surface of the hydrolyzed membrane and metal ions, the washing has little influence on the metal ions attached to the surface of the hydrolyzed membrane.

In the present disclosure, the carboxyl groups on the hydrolyzed membrane and metal ions in the metal salt aqueous solution are subjected to a coordination reaction when impregnating the hydrolyzed membrane in a metal salt aqueous solution, thereby attaching the metal ions onto the surface of the hydrolyzed membrane, and increasing the nucleation sites of the metal-organic framework material.

In some embodiments, the hydrolyzed membrane after impregnated in the metal salt aqueous solution is impregnated in the framework organic solution for 0.5-2 h, for example 0.5 h, 1 h, 1.5 h or 2 h. In some embodiments, after the impregnation in the framework organic aqueous solution is completed, the obtained second impregnated membrane is washed and dried. In some embodiments, the reagent used when washing the obtained second impregnated membrane is water. In some embodiments, the obtained second impregnated membrane is washed for 1-2 times. In some embodiments, the obtained second impregnated membrane is dried at ambient temperature, namely without any other additional heating or cooling. In some embodiments, the obtained second impregnated membrane is dried for 12 h.

In the present disclosure, in some embodiments, after obtaining the metal-organic framework material/membrane composite material, the obtained metal-organic framework material/membrane composite material is stored in deionized water for later use.

In the present disclosure, impregnating the hydrolyzed membrane after impregnated with the metal salt aqueous solution continuously in the framework organic solution makes the metal ions attached to the membrane surface coordinate with the framework in the framework organic solution on the membrane surface, to synthesize metal-organic framework nano-particles in situ.

According to the present disclosure, a large number of carboxyl groups are distributed on the membrane surface due to the hydrolysis of the membrane material, and the carboxyl groups coordinates with the metal ions in the metal salt aqueous solution, resulting in a stable attachment of the metal ions on the surface of the hydrolyzed membrane, thus providing a large number of nucleation sites for the growth of the metal-organic framework material. In addition, a large number of metal-organic framework nano-particles are synthesized in situ on the membrane surface by coordination reaction between the metal ions and the framework in the framework organic solution.

The present disclosure further provides a metal-organic framework material/membrane composite material obtained by the method described in the above technical schemes, comprising a membrane material and a thin layer of metal-organic framework material self-grown on the membrane material, wherein the metal-organic framework material contained in the thin layer has a particle size of 100-200 nm. In some embodiments, the metal-organic framework material is a zeolite imidazolate framework material, for example ZIF-8 or ZIF-67.

In the present invention, since the metal in the metal-organic framework material is combined with the membrane material in the form of coordination bonds, the binding force between the metal-organic framework material and the membrane material is improved, and the particle size distribution of the metal-organic framework material is 100-200 nm, which improves the roughness of the membrane surface; compared with the untreated membrane material and the hydrolyzed membrane with only hydrolysis, the membrane pore size on the membrane surface is significantly reduced, which improves the retention capacity for the organic matter.

The present disclosure further provides a use of the metal-organic framework material/membrane composite material described in the above technical schemes as a filter material in a waste water treatment.

In some embodiments, the waste water contains at least one of bovine serum albumin, sodium alginate and humic acid; that is to say, the metal-organic framework material/membrane composite material may be used to filter at least one of bovine serum albumin, sodium alginate and humic acid in the waste water. In some embodiments, the concentrations of bovine serum albumin, sodium alginate and humic acid are each independently 5 mg/L.

In some embodiments, the use comprises the following step:

using the metal-organic framework material/membrane composite material as a filter membrane to filter waste water.

According to the present disclosure, there is no special limitation to the method of the filtering, and those skilled in the art can set it according to the actual situation.

In some embodiments, the filtering is carried out at a trans-membrane pressure of 0.2 MPa.

The metal-organic framework material/membrane composite material provided by the present disclosure, the preparation method and use thereof will be described in detail below in reference with examples, but they should not be understood to limit the protection scope of the present invention.

### Example 1

A PAN membrane was rinsed with deionized water to remove the impurities on its surface, and then immersed in deionized water for 12 h. The PAN membrane immerged by deionized water was completely immersed in a sodium hydroxide solution (with a concentration of 2 mol/L), and hydrolyzed at 60° C. for 1 h. After hydrolyzed, the obtained PAN membrane was cooled to room temperature, and its surface was then rinsed with deionized water until the rinsed water was neutral, obtaining a hydrolyzed PAN membrane, marked as HPAN membrane.

The hydrolyzed PAN membrane was impregnated in an aqueous solution of zinc nitrate hexahydrate with a molar concentration of 0.04 mol/L for 5 h. After the above impregnation was completed, the surface of the membrane was rinsed with deionized water for 4 times to remove the residual zinc ion solution on the surface of the membrane.

Methanol and ethanol were used as a miscible solvent to prepare a 2-methylimidazole n-hexane organic solution with a molar concentration of 0.08 mol/L, wherein the volumes of methanol, ethanol and n-hexane were 1.9 mL, 2.5 mL and 95.6 mL, respectively. The 2-methylimidazole n-hexane organic solution was slowly poured into the surface of the obtained hydrolyzed PAN membrane impregnated with zinc ion, the resulting mixture was then left to react for 1 h, and the surface of the membrane was then rinsed with deionized water slowly for 3 times and dried at room temperature for 12 h, obtaining a zeolite imidaxole organic framework/membrane composite material, marked as ZIF-8@HPAN membrane, which was stored in deionized water for later use.

### Comparative Example 1

The method for preparing ZIF-8 nano-particles comprises the following steps:

preparation of the aqueous solution of zinc nitrate hexahydrate (Zn(NO₃)₂.6H₂O): 1.5 g of Zn(NO₃)₂.6H₂O was added to 100 mL of deionized water to prepare 0.04 mol/L aqueous solution of Zn(NO₃)₂.6H₂O, and they were stirred with a glass rod until the reagent was completely dissolved in the deionized water;

preparation of 2-methylimidazole (2-Hmim) n-hexane solution: 1.614 g of 2-Hmim was dissolved in 100 mL of n-hexane; since 2-Hmim is insoluble in n-hexane, 1.9 mL of methanol and 2.5 mL of ethanol were added as a miscible solvent;

the methylimidazole (2-Hmim) n-hexane solution was then slowly poured into the aqueous solution of zinc nitrate hexahydrate (Zn(NO₃)₂.6H₂O), they were left for 1 h, and a large amount of white precipitate was generated; the precipitate was centrifuged at 7000 rpm for 20 minutes to obtain a supernatant and a centrifuged product; the supernatant was poured to separate the centrifuged product, and the centrifuged product was washed twice with deionized water, and then dried in an oven at 100° C. overnight, to obtain ZIF-8 nano-particles.

Structure Characterization

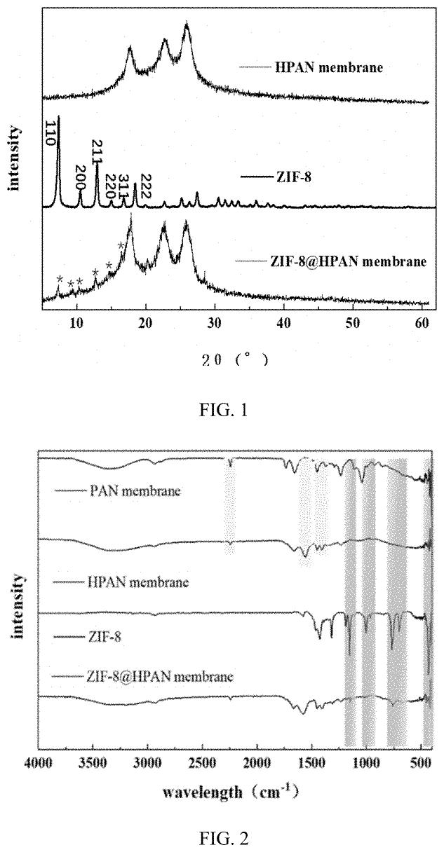

FIG. 1 shows the X-ray diffraction patterns of the ZIF-8 nano-particles obtained in Comparative Example 1, and the HPAN membrane and ZIF-8@HPAN membrane obtained in Example 1. According to literature reports, ZIF-8 material has main characteristic peaks at 20 of 7.4°, 10.4°, 12.7°, 14.7°, 16.4° and 18.0°, respectively. The ZIF-8 material synthesized in Comparative Example 1 was observed to be consistent with the ZIF-8 with a typical SOD structure reported in the literature. By analyzing and comparing the ZIF-8@HPAN membrane and HPAN membrane, it can be seen that there were characteristic peaks of ZIF-8 crystals on the surface of the ZIF-8@HPAN membrane, indicating that ZIF-8 nano-particles were successfully loaded on the HPAN membrane.

FIG. 2 shows the infrared spectrums of the PAN membrane, the ZIF-8 nano-particles obtained in Comparative Example 1, and the HPAN membrane and ZIF-8@HPAN membrane obtained in Example 1. According to literature reports, for PAN membrane the peak at 2243 cm′ was assigned to a nitrile group (—CN). It can be observed from FIG. 2 that after the hydrolysis in the NaOH aqueous solution, there were still some CN groups existing on the HPAN membrane, indicating that not all of the CN groups were converted to carboxyl (—COOH) groups; meanwhile it was observed that the absorption intensity of CN groups was weakened after the hydrolysis. Further to that, new absorption peaks at 1568 cm⁻¹ and 1405 cm⁻¹ were observed in the infrared spectrum of the HPAN membrane, confirming that —COOH groups were produced on the surface of the membrane after hydrolysis. The loading of ZIF-8 nano-particles on the hydrolyzed membrane was observed from the infrared spectrum, and the signal at 1300-1460 cm′ was assigned to the whole ring stretching, and the signal at 1146 cm⁻¹ was assigned to aromatic C—N stretching mode. Meanwhile, the peaks at 996 cm⁻¹ and 760 cm⁻¹ were assigned to C—N bending vibration and C—H bending mode, respectively. In addition, an absorption peak was generated at 694 cm⁻¹ due to the out-of-plane bending vibration of the methylimidazole ring. At the same time, a Zn—N stretching vibration band at 416 cm⁻¹ was observed, confirming that the chemical combination of zinc ion with nitrogen atom in 2-methylimidazole promoted the formation of imidazolate salt. Although the characteristic peaks of ZIF-8 particles overlapped with the peaks of HPAN support to a certain extent, some peaks still appeared clearly in the infrared spectrum of the ZIF-8@HPAN membrane, indicating that a ZIF-8 layer was successfully loaded on the HPAN support layer.

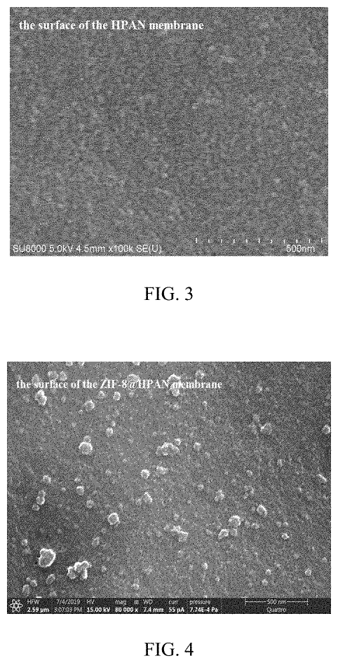

FIGS. 3-5 show scanning electron micrographs of the surface of the HPAN membrane, the surface and cross section of the ZIF-8@HPAN membrane obtained in Example 1, respectively. It can be seen from FIGS. 3-5 that the surface of the HPAN membrane was smooth and evenly distributed with many membrane pores, and the pore size of the membrane pore was large, while the ZIF-8@HPAN membrane had a surface loaded with many ZIF-8 particles with a particle size of about 100 nm, its surface was rough, and the pore size of the membrane pores was obviously reduced. In addition, from the electron micrograph of the cross section of the ZIF-8@ HPAN membrane, it can be seen that a relatively uniform and dense ZIF-8 layer with a thickness of only 250-300 nm was formed on the surface of the HPAN membrane. It showed that the thickness of the ZIF-8 composite membrane prepared by the interfacial polymerization was controllable and has a certain feasibility.

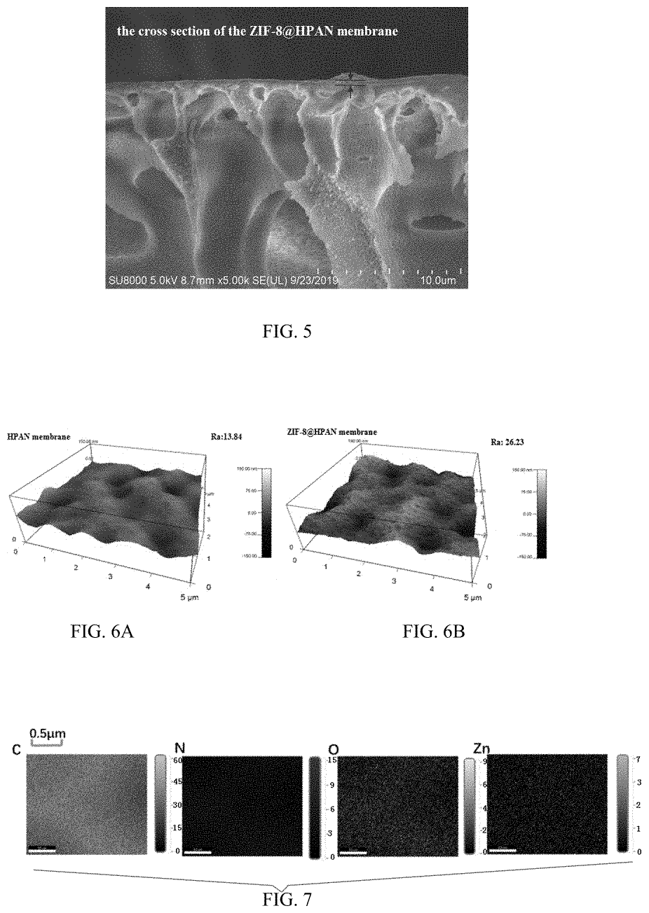

FIGS. 6A, 6B show the three-dimensional images of the surface roughness of the HPAN membrane and the ZIF-8@HPAN membrane obtained in Example 1, in which the bright area usually represents the convex position of the membrane surface, while the dark area represents the concave position of the membrane surface. As shown in the results of the roughness parameters of the membrane, the HPAN membrane had a Ra value of about 13.84, and had a relatively smooth membrane surface and obviously depressed membrane pores; while the Ra value of the ZIF-8@HPAN membrane increased to about 26.23, indicating that the roughness of the surface of the ZIF-8@ HPAN membrane increased, and at the same time, due to the presence of the ZIF-8 particles, the depression degree of the membrane pore decreased, which to some extent indicated that the ZIF-8 layer formed on the surface of the HPAN membrane was denser.

FIG. 7 shows the distribution diagrams of different elements on the surface of the ZIF-8@ HPAN membrane obtained in Example 1, wherein different colors represent different elements, and the element content is expressed according to the light spot distribution and density during scanning. It can be seen from FIG. 7 that the light spot distributions of C and N elements were the densest, which was due to the fact that that on the one hand, the PAN membrane was composed of C and N elements, and on the other hand, the organic ligand 2-methylimidazole constituting ZIF-8 was mainly composed of C and N elements. In addition, Zn element was also observed to be densely distributed on the membrane surface. The elements contained in the ZIF-8 were mainly C, H and Zn, wherein Zn element was the characteristic element of the ZIF-8. The result of the uniform distribution of C, N and Zn elements on the membrane surface indicated that ZIF-8 nano-particles had been successfully loaded on the surface of the HPAN membrane by the interfacial polymerization.

### Use Examples

The ZIF-8@HPAN membrane prepared in Example 1 was applied to filter humic acid, bovine serum albumin and sodium alginate.

The steps of the use were as follows: an ultrafiltration terminal filtration apparatus was used, and a ZIF-8@HPAN membrane with an area of 4.91 cm² was fixed at the bottom of an ultrafiltration cup. Then they were placed on an electronic balance, and simultaneously connected with a nitrogen bottle, and a membrane flux test was then carried out. At room temperature, the ZIF-8@HPAN membrane was compacted by ultrapure water at a pressure of 0.2 MPa, and the mass of the filter materials passing through the ZIF-8@HPAN membrane was recorded online by a computer every 30 seconds. For each group of the ZIF-8@HPAN membrane, three sets of parallel samples were used to reduce the influence of errors on the experiment, and the permeation flux per unit time (J) was recorded. The calculation formula is:

$$J = \frac{W}{At Δ P} ; \qquad formula I$$

wherein W is a permeation flux after filtering pollutants for a period of time t under the conditions of an operating pressure P and an effective area A of the ZIF-8@HPAN membrane, and it is in a unit of L; P is in a unit of MPa; A is in a unit of m²; t is in a unit of h.

In the experimental design, each ZIF-8@HPAN membrane was used with a trans-membrane pressure difference of 0.2 MPa at room temperature, the membranes were used to filter deionized water for 30 min to obtain a stable flux, then to filter the organic solution for 30 min, and the retention rate was calculated. The calculation formula is:

$$R = 100 \times ( 1 - \frac{{C}_{p}}{{C}_{f}} ) ; \qquad formula II$$

wherein Cₚ and C_{f} represent concentrations of the original organic matter and filtered organic matter respectively.

Herein, the change of the organic matter content was characterized by water quality indexes UV₂₅₄ and TOC.

1. The Effect of Different Contacting Time Between the HPAN Membrane and Precursor Zinc Ion on the Performance of a Metal-Organic Framework Material/Membrane Composite Material.

According to the method in Example 1, the HPAN membranes were impregnated in an aqueous solution of zinc nitrate hexahydrate with a molar concentration of 0.02 mol/L and subjected to a contacting reaction for 1 h, 2 h, 5 h and 10 h respectively. After that, the obtained membranes were subjected to an interfacial reaction with a 2-methylimidazole n-hexane organic solution with a concentration of 0.04 mol/L for 1 h to obtain ZIF-8@HPAN membranes with different contacting time between HPAN membranes and zinc ions. According to the operation steps of the Use Example, a humic acid with a concentration of 5 mol/L was used as an organic solution, and under the conditions of a trans-membrane pressure of 0.2 MPa and room temperature, the ZIF-8@HPAN membranes were used to filter deionized water for 30 min to obtain a stable flux, then to filter the organic solution for 30 min, and the permeation flux and retention rate were calculated.

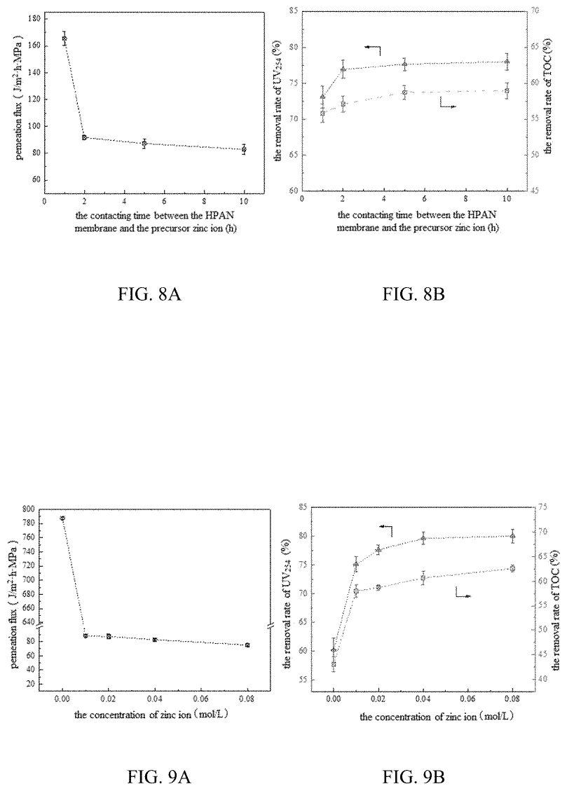

FIGS. 8A, 8B show variations of the permeation flux, UV₂₅₄ removal rate and TOC removal rate of the HPAN membrane with contacting time with precursor zinc ions. It can be seen from FIGS. 8A, 8B that as the contacting time between the HPAN membrane and zinc ions solution increased from 1 h to 10 h, the permeation flux decreased from 163.2 L/m²·h·MPa to 82.5 L/m²·h·MPa, the removal rate of UV₂₅₄ increased from 73.12% to 78.02%, and the removal rate of TOC also increased from 55.86% to 59%; the decreasing of permeation flux and the increasing of removal rate was due to the increasing of the ZIF-8 nano-particles on the membrane surface as the contacting time between the HPAN membrane and zinc ions increased. It can be seen that the contacting time of 5 h between the HPAN membrane and zinc ions was an optimized contacting time.

2. The Effect of Different Zinc Ion Concentrations on the Performances of the Metal-Organic Framework Material/Membrane Composite Material.

According to the method in Example 1, the HPAN membranes were impregnated in aqueous solutions of zinc nitrate hexahydrate with molar concentrations of 0.01 mol/L, 0.02 mol/L, 0.04 mol/L and 0.08 mol/L respectively and subjected to contacting reactions for 5 h. After that, the obtained HPAN membranes were subjected to interfacial reations with a 2-methylimidazole organic solution with a molar concentration of 0.04 mol/L for 1 h to obtain ZIF-8@ HPAN membranes with different concentrations of zinc ion. The permeation flux and retention rate were studied respectively by the operation steps of the above Use Example.

FIGS. 9A, 9B show variations of the permeation flux, UV₂₅₄ removal rate and TOC removal rate of the ZIF-8@HPAN membrane with the concentration of zinc ion. It can be seen from FIGS. 9A, 9B that as the concentration of zinc ion increased from 0.01 mol/L to 0.08 mol/L, the permeation flux of the membrane decreased from 87.66 L/m²·h·MPa to 76.25 L/m²·h·MPa, while the removal rate of aromatic macromolecular organics in raw water increased from 75.12% to 80.03%, and the removal rate of TOC increased from 57.98% to 62.58%. It can be inferred that ZIF-8 particles loaded on the membrane surface gradually increased and grew more densely as the zinc ion concentration increased; when the zinc ion concentration was 0.08 mol/L, the ZIF-8 nano-particles loaded on the membrane surface have a certain agglomeration, and the membrane pore size on the membrane surface decreased to some extent, thereby leading to a lower permeation flux and a higher retention rate. Therefore, the optimized molar concentration of zinc ion was 0.04 mol/L.

3. The Effect of Different Molar Concentration Ratios of 2-Methylimidazole (Hmim) to Zn²⁺ on the performance of the metal-organic framework material/membrane composite material.

ZIF-8@ HPAN membranes with different molar concentration ratios of Hmim/Zn²⁺ were prepared according to the method in Example 1, wherein the molar concentration ratios of Hmim/Zn²⁺ were designed as 1, 2, 4 and 8, the concentration of zinc ion was defined as 0.04 mol/L, and the concentration of 2-methylimidazole increased from 0.04 mol/L to 0.32 mol/L.

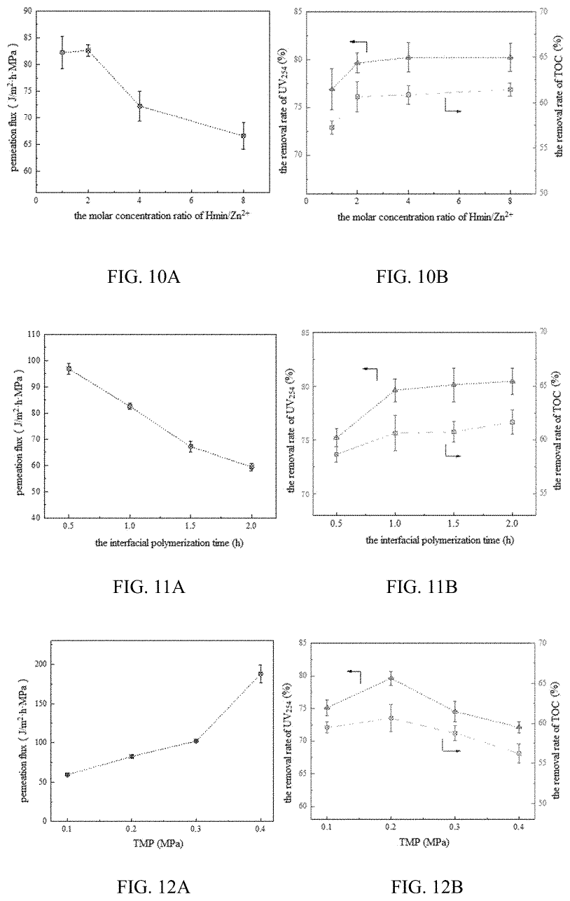

FIGS. 10A, 10B show variations of the permeation flux, UV₂₅₄ removal rate and TOC removal rate with the molar concentration ratio of Hmim/Zn²⁺. It can be seen from FIGS. 10A, 10B that as the molar concentration ratio increased, the permeation flux of the membrane decreased from 81 L/m²·h·MPa to 66 L/m²·h·MPa. However, for the removal rates of UV₂₅₄ and TOC, when the molar concentration ratio increased from 1 to 2, the removal rate of organics in a raw filtrate increased significantly; while when the molar concentration ratio increased from 2 to 4, the change of the removal effects in terms of UV₂₅₄ and TOC were relatively slight; when the molar concentration ratio was 8, the removal rates of UV₂₅₄ and TOC reached 80.23% and 61.46% respectively. This may be because the higher the concentration of 2-methylimidazole, the higher the nucleation rate of ZIF-8 particles grown on the surface of the membrane, and the smaller the size of the ZIF-8 particles grown on the surface of the membrane, and thereby the denser the ZIF-8 layer formed on the surface of the membrane, resulting in a reduced permeation flux. Therefore, the optimized molar concentration ratio of Hmim/Zn²⁺ was 2.

4. The Effect of Different Interfacial Polymerization Time on the Performances of Metal-Organic Framework Material/Membrane Composite Material.

ZIF-8@HPAN membranes were prepared according to the method in Example 1, wherein the molar concentration of zinc ions was 0.02 mol/L, the HPAN membranes were subjected to a contacting reaction with zinc ions for 5 h, the molar concentration of the 2-methylimidazole n-hexane organic solution was 0.04 mol/L, and the interfacial polymerization time was designed as 0.5 h, 1, 1.5 h and 2 h, respectively.

FIGS. 11A, 11B show variations of the permeation flux, UV₂₅₄ removal rate and TOC removal rate of the membranes with the interfacial polymerization time. It can be seen from FIGS. 11A, 11B that as the interfacial polymerization proceeded, the permeation flux decreased from 97 L/m²·h·MPa to 59 L/m²·h·MPa, the removal rate of UV₂₅₄ for humic acid increased from 75.23% to 80.46%, and the removal rate of TOC also increased from 58.65% to 61.68%. Therefore, the optimized interfacial polymerization time was 1 h.

5. A Study on the Effect of Different Trans-Membrane Pressure on the Removal of Humic Acid.

The ZIF-8@HPAN membrane prepared by Example 1 was used as a membrane material, and the trans-membrane pressures were designed as 0.1 MPa, 0.2 MPa, 0.3 MPa and 0.4 MPa in the experiment.

FIGS. 12A, 12B show variations of the permeation flux, UV₂₅₄ removal rate and TOC removal rate with the trans-membrane pressure. It can be seen from FIGS. 12A, 12B that as the trans-membrane pressure (TMP) increased from 0.1 MPa to 0.4 MPa, the permeation flux of the membrane increased gradually, significantly from 52 L/m²·h·MPa to 186 L/m²·h·MPa; it was observed that when the TMP increased from 0.1 to 0.2 MPa, the retention capacity of the ZIF-8@ HPAN membrane for aromatic macromolecules in the humic acid solution increased from 75.12% to 79.64%; while when the TMP further increased to 0.4 MPa, the retention capacity of the ZIF-8@HPAN membrane for aromatic macromolecules in the humic acid solution decreased to 72.14%. The removal rate of TOC also showed a similar trend, rising from 59.48% to 60.65% first, and then decreasing to 56.12%. This was because when the TMP increased to 0.4 MPa, the pressure the surface of the ZIF-8@HPAN membrane withstood exceeded the maximum pressure required when using the membrane for production, resulting in a sudden increase in the permeation flux and a decrease in the retention effect for organics.

6. The Effect of the HPAN Membrane and ZIF-8@HPAN Membrane Obtained in Example 1 on the Removal of Organics in the Humic Acid.

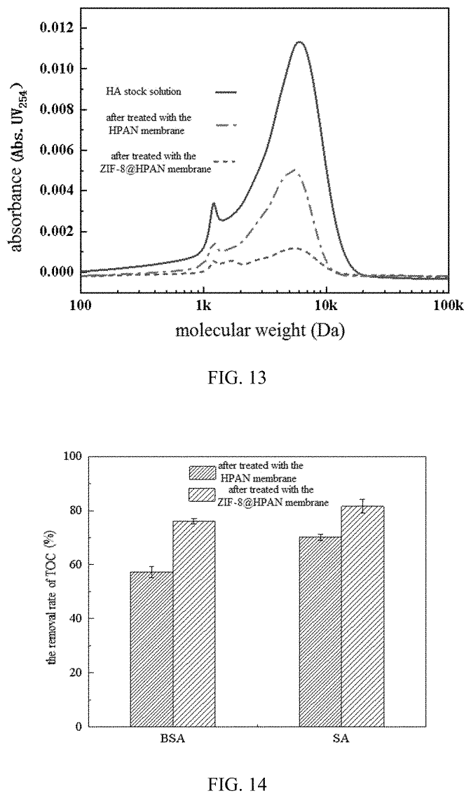

The effect of the HPAN membrane and ZIF-8@HPAN membrane obtained in Example 1 on the removal of organics in the humic acid was studied by the steps of the Use Example. FIG. 13 shows the graphs of molecular weight distribution of humic acid before and after treated with the HPAN membrane and ZIF-8@ HPAN membrane obtained in Example 1. According to literature reports, the molecular weight of macromolecular organic components were mainly distributed in a range of >4 kDa, the molecular weight of medium molecular components were mainly distributed in a range of 1-4 kDa, and the molecular weight of small molecular components were mainly distributed in a range of <1 kDa. The humic acid mainly comprised a medium molecular organic component with a molecular weight of 1 k-4 k and a macromolecular organic component with a molecular weight of 4 k-11 k. After treated with the HPAN membrane, in the humic acid, the absorbance at a molecular weight distribution of 1 k-2 k decreased from 0.0038 to 0.0015, the absorbance at a molecular weight distribution of 2 k-11 k decreased from 0.016 to 0.0056, and the removal rate was only about 50%. After treated with the ZIF-8@HPAN membrane, in the humic acid, the content of the medium molecular weight substances and macromolecular substances, with a molecular weight of 1 k-2 k and 2 k-11 k respectively, both decreased by about 90%. The results showed that the ZIF-8@ HPAN membrane had a good ability to remove humic acid.

7. The Effect of the HPAN Membrane and ZIF-8@HPAN Membrane Obtained in Example 1 on the Removal of Bovine Serum Albumin (BSA) and Sodium Alginate (SA).

The effect of the HPAN membrane and ZIF-8@HPAN membrane obtained in Example 1 on the removal of bovine serum albumin (BSA) and sodium alginate (SA) was studied according to the steps in Use Example, and FIG. 14 shows the TOC removal rates of bovine serum albumin and sodium alginate after treated with the HPAN membrane and ZIF-8@ HPAN membrane obtained in Example 1. It can be seen from FIG. 14 that after treated with the HPAN membrane, the TOC contents in BSA solution and SA solution decreased by 57.37% and 70.15% respectively, while after treated with the ZIF-8@HPAN membrane, the removal rates of TOC in the BSA solution and SA solution increased to 76.1% and 81.59% respectively. The results showed that the ZIF-8@HPAN membrane had a stronger ability to remove bovine serum protein and sodium alginate.

It can be seen from Example 1 that the ZIF-8@HPAN membrane provided in this example had a lower permeation flux and a higher retention rate than those of the HPAN membrane; after the modification of the ZIF-8@HPAN membrane, the membrane pore size decreased, resulting in a decrease in the permeate flux. In addition, the surface of the ZIF-8@HPAN membrane was loaded with a dense ZIF-8 layer, which improved the selective functionality of the composite membrane and increased the retention rate of organics.

### Example 2

A PTFE membrane was rinsed with deionized water to remove the impurities on its surface, and then immerged in deionized water for 12 h. The PTFE membrane immerged by deionized water was completely immersed in a sodium hydroxide solution (with a concentration of 3 mol/L), and hydrolyzed at 70° C. for 2 h. The obtained PTFE membrane was cooled to room temperature, and its surface was then rinsed with deionized water until the rinsed water was neutral, obtaining a hydrolyzed PTFE membrane, marked as HPTFE membrane.

The obtained HPTFE membrane was impregnated in an aqueous solution of cobalt nitrate hexahydrate with a molar concentration of 0.04 mol/L for 5 h. After the above impregnation was completed, the surface of the membrane was rinsed with deionized water for 4 times to remove the residual cobalt ion solution on the surface of the membrane.

Methanol and ethanol were used as a miscible solvent to prepare a 2-methylimidazole n-hexane organic solution with a molar concentration of 0.08 mol/L, wherein the volumes of methanol, ethanol and n-hexane were 1.9 mL, 2.5 mL and 95.6 mL, respectively. The 2-methylimidazole n-hexane organic solution was slowly poured into the surface of HPTFE membrane impregnated in a cobalt ion solution, and the obtained mixture was then left to react for 1 h, and the surface of the membrane was then rinsed with deionized water slowly for 3 times and dried at room temperature for 12 h, to obtain a zeolite imidazole organic framework/membrane composite material, marked as ZIF-67 @HPTFE membrane, which was stored in deionized water for later use.

The obtained ZIF-67@HPTFE membrane was tested for its removal effect for a single organic of humic acid, bovine serum albumin or sodium alginate. The results were as follows: after treated with the ZIF-67@HPTFE membrane, in the humic acid, the contents of medium and high molecular weight substances, with a molecular weight 1 k-2 k and 2 k-11 k respectively, both decreased by about 90%; after treated with the ZIF-67@HPTFE membrane, the removal rates of TOC in humic acid, bovine serum albumin and sodium alginate were 62%, 75% and 80%, respectively. Compared with the HPTFE membrane, the removal effect for single organic was improved by nearly 20-30%.

The above are only the preferred embodiments of the present disclosure. It should be noted that for those ordinary skilled in the art, several improvements and modifications could be made without departing from the principle of the present disclosure. These improvements and modifications should also be within the protection scope of the present disclosure.

What is claimed is:

1. A method for preparing a metal-organic framework/membrane composite material, comprising the following steps:
mixing a membrane material with an alkali liquor, and performing a hydrolysis to obtain a hydrolyzed membrane; and
impregnating the hydrolyzed membrane in a metal salt aqueous solution and a framework organic solution in sequence, to form a metal-organic framework material/membrane composite material.

2. The method as claimed in claim 1, wherein the membrane material is selected from the group consisting of a polyacrylonitrile membrane, a polytetrafluoroethylene membrane and a bisphenol polysulfone membrane.

3. The method as claimed in claim 1, wherein the alkali liquor has a concentration of 1-3 mol/L.

4. The method as claimed in claim 1, wherein the hydrolysis is performed at a temperature of 50-65° C. for 1-3 h.

5. The method as claimed in claim 3, wherein the hydrolysis is performed at a temperature of 50-65° C. for 1-3 h.

6. The method as claimed in claim 1, wherein the metal salt aqueous solution is selected from the group consisting of a cobalt salt aqueous solution and a zinc salt aqueous solution; the framework organic solution is a 2-methylimidazole n-hexane organic solution.

7. The method as claimed in claim 1, wherein the metal salt aqueous solution has a concentration of 0.01-0.08 mol/L, and the molar concentration ratio of the metal salt aqueous solution to the framework organic solution is 1:(1-8).

8. The method as claimed in claim 6, wherein the metal salt aqueous solution has a concentration of 0.01-0.08 mol/L, and the molar concentration ratio of the metal salt aqueous solution to the framework organic solution is 1:(1-8).

9. The method as claimed in claim 1, wherein the hydrolyzed membrane is impregnated in the metal salt aqueous solution for 1-10 h.

10. The method as claimed in claim 1, wherein the hydrolyzed membrane is impregnated in the framework organic solution for 0.5-2 h.

11. The method as claimed in claim 9, wherein the hydrolyzed membrane is impregnated in the framework organic solution for 0.5-2 h.

12. A metal-organic framework material/membrane composite material obtained by the method as claimed in claim 1, comprising a membrane material and a thin layer of metal-organic framework material self-grown on the membrane material, wherein the metal-organic framework material contained in the thin layer has a particle size of 100-200 nm.

13. A method for treating waste water by using the metal-organic framework material/membrane composite material as claimed in claim 12, comprising using the metal-organic framework material/membrane composite material as a filter material to filter waste water.
